(19) United States
(12) Patent Application Publication
(10) Pub. No.: US 2004/0134607 A1
(43) Pub. Date: Jul. 15, 2004

(54) Kit of adhesion-release agents

(76) Inventors: Anthony John Ryan, Sheffield (GB); Colin James Crook, Sheffield (GB); John Patrick Anthony Fairclough, Sheffield (GB); Richard Anthony Lewis Jones, Sheffield (GB)

Correspondence Address: JACOBSON HOLMAN PLLC, 400 SEVENTH STREET N.W., SUITE 600, WASHINGTON, DC, 20004, US

(21) Appl. No.: 10/362,357

(22) PCT Filed: Aug. 30, 2001
(86) PCT No.: PCT/GB01/03870

(30) Foreign Application Priority Data
Sep. 7, 2000 (GB) 00219212

(51) Int. Cl. C09J 4/00

(52) U.S. Cl. 156/331.4

(57) ABSTRACT

Kit of adhesion agents for adhering substrates, wherein the kit comprises a plurality of reactive block copolymers of formula I:

R¹-(AB)ₘ(A)ₙ-R² I

wherein n=0 or 1 and when n=0 R¹ is different from, and reacts with R², when n=1 R¹=R², and wherein m=1 or a whole number integer, and

wherein each copolymer I has a molecular weight in the range 2000-20,000, A and B are blocks of repeating units selected from known thermoplastic resin types and are substantially immiscible and R¹ and R² comprise reactive end groups, wherein the block copolymers have order-disorder transition (ODT) at a temperature Tₜ in the range 10-75° C. corresponding to a desired range of adhesion application temperatures, and are liquid at a processing temperature Tₚ and solid at a service temperature T_{t.;} kit of polymer resins of formula II and III for preparing a plurality of polymer resins of formula I; polymer resins for use therein; novel adhesion-release agents; compositions thereof; methods for the preparation thereof and for adhering or releasing substrates; a programmed computer and the use thereof in selection of agents.

The present invention relates to a kit of temperature regulated adhesion and/or release agents for adhering and/or releasing surfaces of respective substrates and a method for the preparation thereof, a kit of precursors therefor, novel adhesion-release agents, a method for adhering and/or releasing substrates using the agents, a method for selecting an agent for any given pair of substrates, a computer programmed for selection thereof, and the use in adhering and/or releasing substrates in packaging, surgery, moulding and the like. More particularly the invention relates to a kit of temperature regulated adhesion or release agents comprising reactive block copolymers having order-disorder transition at a desired temperature, the kit of precursors, novel agents and associated methods.

### INTRODUCTION/BACKGROUND OF THE INVENTION

Block copolymers comprise two or more chemically incompatible chains (blocks) joined together at their ends by covalent bonds. They have many diverse structures and surface-activities, all dominated by the tendency of the blocks to microphase separate when the temperature is lowered. If a homogeneous melt of block copolymers is cooled, at some temperature interactions between different blocks will be unfavourable and unlike monomer units will try to segregate. However, phase separation per se is impossible, as the unlike blocks are covalently linked. Thus, a block copolymer undergoes a local ordering process (microphase separation) below a critical temperature (the microphase separation temperature or order disorder transition temperature, MST or ODT) to form free energy-minimising ordered structures, which are dependent on the composition. The chains aggregate together because of similarities in polarity and hydrogen bonding, and the associated blocks (microdomains) are, in effect, pseudo-crosslinks, acting as reinforcing filler between disordered chains. These domains affect modulus, hardness and tear strength and reduce compression and extension under load. The composition and degree of chain interaction determines the elastomeric properties of the bulk polymer.

Block copolymers have been used in a wide variety of applications typical of resins. For example they have particular application as adhesives and thermoplastic elastomers.

Styrene-isoprene-styrene block copolymers (Kraton® Shell Chemicals) are known as the high molar mass polymer in pressure sensitive adhesive (PSA) blends. The physical crosslinks formed by the glassy blocks (PS) below the T_{g} of PS provide a very high creep resistance, while heating above the T_{g} decreases the viscosity dramatically, allowing hot-melt processing. These polymers are blended with a tackifying resin for pressure adhesion to a surface, and a plasticiser for reduced viscosity processing. The degree of compatibility of the resin with each of the blocks can affect the PSA properties. If the resin is compatible with the PS end block, it increases the range of useful temperatures and allows hot-melt processing at lower temperatures by lowering the T_{g} of the styrene.

Hot-melt adhesives are solid at room temperature, melt to a viscous liquid when heated to moderate temperatures (240° C.), and are applied in the molten state. The adhesive then cools to a solid state to provide initial bond strength (i.e. green strength) Reactive hot-melt adhesives (RHM's) are urethane based systems which additionally cure on contact with ambient moisture, by virtue of excess isocyanate functional groups in the formulation, to provide higher final bond strength. The primary limitation of RHMs is poor adhesion to some substrates due to insufficient wetting.

The present invention provides a ‘toolbox’ or kit of reactive block copolymer adhesion-release agents, which combine the 100% solids and curing of reactive hot-melts with the contact adhesion mechanism of emulsion and solution synthesised products, and additionally introducing novel temperature regulating adhesion and release mechanisms. The ‘toolbox’ block copolymers are one-component (reactive) formulations as opposed to the blend systems of typical PSAs. The attraction of the ‘toolbox’ of block copolymers is the possibility of tailoring the structure and selecting a copolymer that suits both substrates to be adhered and/or released, with increased tack or adhesion which takes place at the ODT by virtue of the creation of micro phase separation interfaces. The toolbox is tailored to a desired use according to the property changes of the adhesion-release agents.

According to the present invention there is provided a kit of adhesion and/or release agents for adhering and/or releasing substrates, wherein the kit comprises a plurality of reactive block copolymers of formula I:

R¹-(AB)ₘ(A)ₙ-R² I

wherein n=0 or 1 and when n=0 R¹ is different from, and reacts with R², when n=1 R¹=R², and wherein m=1 or a whole number integer, and

wherein each copolymer I has a molecular weight in the range 2000-20,000, A and B are blocks of repeating units selected from known thermoplastic resin types and are substantially immiscible and R¹ and R² comprise reactive end groups, wherein the block copolymers have order-disorder transition (ODT) at a temperature Tₜ in the range 10-75° C. corresponding to a desired range of adhesion and/or release application temperatures, and are liquid at a processing temperature Tₚ and solid at a service temperature Tₛ.

Preferably the blocks A and B are of type H and S, representing crystalline, glassy and soft rubbery blocks as known in the art.

Reference herein to a processing temperature T_{P} is to a temperature in excess of T_{T} at which an adhesion-release agent is to be dispensed.

Reference herein to a service temperature T_{S} is to a temperature at which substrates are to be used and adhesion and/or release is desired to be effective. The relation of the temperatures is Tₚ>T_{T}>T_{S}.

Reference herein to an adhesion-release agent is to any adhesion and/or release agent which brings about adhesion and/or release reversibly, temporarily or permanently, e.g. adhesives, binders, release agent, lubricants etc.

According to the present invention the ODT temperature can be controlled through the molecular weight of the blocks or vice versa and the relationship is governed by a value Chi wherein Chi is the Flory-Huggins interaction parameter and equal to a/T+b, in which T is temperature and a and b are known system dependent constants related to the polymer type.

Preferably the kit as hereinbefore defined comprises a plurality of reactive block copolymers I as hereinbefore defined characterised by a value Chi N at the service temperature T_{S} in the range 5-60, preferably 7-40, more preferably 10-30; wherein Chi is as hereinbefore defined, T=T_{S} and is preferably in the range 0-100° C., more preferably 10-40° C., N is the degree of polymerisation given by NMo=MW, Mo is the molecular weight of a monomer unit, and MW is the molecular weight of the polymer.

In this way a block copolymer can be designed to be a liquid at the processing temperature, while at the service temperature it is a solid whose surfaces are automatically compatible with the substrates with which it is in contact.

Preferably the kit of the invention is for temperature switchable adhesion and release of substrates with release by cooling significantly below ODT, wherein the copolymer I has Chi N_{ODT} at a temperature T_{T} just above the service temperature as defined and has Chi N_{R} at a release temperature T_{R}, wherein T_{S}>T_{R}, which provides release or debonding by virtue of loss of adhesion. Preferably Chi N_{R} is approximately 10× Chi N_{ODT}, which corresponds to Chi_{R}>>Chi_{S}, for example Chi_{R} is in the range 50-600 and this typically corresponds to T_{R}=T_{S}−(50-100° C.).

This is in contrast to a regular release agent according to the invention in which Chi N is as hereinbefore defined and causes release at ODT.

It is a particular advantage that the kit of the invention provides in use a film between substrates for adhesion or release and the like. Adhesion or release is determined for any given substrate pair, according to the ODT which is a function of temperature and of molecular weight for any given block copolymers. Surprisingly agents are provided with relatively low molecular weight allowing easy dispensing without the need to add plasticizer, modifier, solvent or the like, yet exhibit excellent bond strength or release and mechanical performance.

Selection of blocks may be by a complex inter relation of variables, for example a selection of higher MW provides better phase separation and may require a selection of polymer type having low Chi for ODT, in contrast a block copolymer can be provided at lower MW than a corresponding regular polymer, and requiring selection of polymer type having large Chi for ODT, providing tackiness or adhesion at an equivalent temperature to a corresponding higher MW regular polymer adhesive.

On application of adhesion-release agents, “green strength” would be provided by the microphase separation process and this would then be enhanced by the moisture crosslinking of the reactive groups, for example the isocyanate end groups.

Substrates to be adhered and/or released may be of any desired type, and may be compatible or incompatible materials, it is a particular advantage that the agents of the invention are able to adhere incompatible substrates.

In order to make a good adhesive bond or clean release between substrates, each surface of the film must be compatible with the surface it is in contact with. For example, to bond a polar and a non-polar surface would require both polar and non-polar affinities. Porous materials, such as paper and board, and non-porous materials, such as polymer films, require different surface interactions with an adhesive to form a bond.

Incompatible substrates can therefore be of same or different type, e.g.:

glassy polymer/glassy polymer

glassy polymer/inorganic (e.g. glass)

glassy polymer/non-polar polymer

glassy polymer or inorganic/elastomer or polymer melt

polymer melt/polymer melt etc

Block copolymers are attractive as adhesives when bonding incompatible substrates because their natural tendency to self-assemble allows them to present a different surface chemistry to each of the incompatible substrates. When the block copolymer orders, the effect of the substrate on the mechanism of microphase separation is such that each substrate will be in contact with the substrate with which it is compatible.

An adhesion-release agent according to the present invention may be a releasable adhesive which reorders on application of heat or pressure, or may be semi or permanently bonding, by means of cross linking formation for example on application of moisture or radiation such as UV or the like. It is a particular advantage that adhesion-release agents are provided as one component formulation which serve to adhere and/or release substrates at ambient service temperature.

The kit of the invention comprises a plurality of reactive block copolymers of formula I as hereinbefore defined and preferably wherein each A and R¹ and/or each B and R² respectively are of the same type and different MW, more preferably are a range of molecular weights. More preferably block copolymers of formula I are provided in a plurality of MW sub ranges, for example in the range 2000-4000, 4000-5000, 5000-6000, 6000-8000, 8000-12000 and 12000-20,000. Suitable molecular weight ranges for any given block copolymer of Formula I are preferably such as to enable selection of block copolymers having ODT in a useful service temperature range, for example in the range 10-40° C.

A and B may be selected from blocks comprising any thermoplastic polymers, which may be the same as one of the dissimilar substrates to be adhered, thereby having an affinity for the substrate, or may be different to the substrate but have an affinity therefor, preferably selected from polybutadiene (PB), poly(ethylene terephthalate) (PET), polyether, polyester, polyamide, polyolefins such as polypropylene (PP) or polyethylene (PE), polycaprolactone (PCL), polystyrene (PS) and poly(ethylene oxide) (PEO). Affinity may be determined in terms of similar solubility parameters. For example, an adhesive based on PET and PEO could be very effective for bonding paper and PET, whereas an adhesive based on PE and PCL could be very effective for forming resealable bonds (i.e. non-porous) between PE and PET.

R¹ and R² may be selected from any reactive end groups; preferably OH, OR, halo (Cl, I), ⁱOCN, CO₂H, NH₂, CONH₂, CO₂R; more preferably R¹ is selected from OH, OR, CO₂H, CO₂R and R² is selected from ⁱOCN, OCOC(CH₃)═CH₂ (for UV curing); most preferably R¹ is OH and R² is ⁱOCN.

Preferably reactive end groups react to form covalent bonds at a suitable copolymerisation temperature.

A selection of polymer end groups may be made according to desired properties. For example end groups may be associated with cross linking properties, for example isocyanate end groups provide moisture activated cross linking. It is a particular advantage that a polymer composition comprising a tri block copolymer may comprise as terminal end groups the end groups of one of the two constituent monomers from which it derived having desired properties, for example to enable cross linking by moisture curing (R¹=ⁱOCN), UV or the like.

The block copolymer of formula I may provide enhanced properties such as mechanical performance, electrical conductivity, heat or flame resistance or retardance, solvent resistance and the like, by incorporating additional dopants, functional groups and the like.

An agent according to the present invention may be a di, tri or multi block copolymer. Preferably an adhesion-release agent is a multiblock copolymer. Multiblock copolymers are characterised by bicontinuous microphase structures which are more advantageous than well defined long range order.

In a further aspect of the invention there is provided a kit for adhering and/or releasing dissimilar substrates comprising a plurality of polymer resins of formula II and III which are suitable for preparing a plurality of block copolymers of formula I as hereinbefore defined in desired MW for any given polymer pair AB:

II R¹AR¹ III R²BR²

In a further aspect of the invention there is provided a novel block co-polymer adhesion-release agent of formula I

R¹-[AB]ₘ(A)ₙ-R² I

Wherein R¹, R², A and B, n and m are as hereinbefore defined and one or both of R¹ and R² is ⁱOCN, and if R² is different from and reactive with R¹, R² is OH providing a copolymer molecular weight in the range 2,000 to 20,000.

In a further aspect of the invention there is provided an adhesion-release agent of formula I, or polymer resin of formula II or III for the preparation thereof for use in a kit as defined.

In a further aspect of the invention there is provided composition comprising polymer resins of formulae II and III as defined or formula I, in substantial absence of added tackifying resin, plasticizer and the like.

A block copolymer or composition according to the invention may be provided in any suitable form. In a particular advantage an adhesion-release agent or composition according to the invention is provided in a suitable dispensing device comprising the block copolymer, for example in a reservoir of a pen, brush, stick or the like.

In a further aspect of the invention there is provided a process for the preparation of an adhesion-release agent as hereinbefore defined comprising the condensation of a polymer resin of formula II with a polymer resin of formula III as hereinbefore defined under reaction conditions of elevated temperature and/or pressure, with termination of polymerisation at desired degree of polymerisation N or molecular weight by addition of end capping component or by reaction quench, for example temperature or pressure reduction or removal of solvent, if present. N is determined statistically by controlled reaction time and temperature and/or sampling or in situ viscosity measurement or spectroscopic techniques as known in the art.

Polymer resins may be obtained commercially or by known means, (“The Physics of Glassy Polymers”, R N Haward & R J Young, 1997, Chapman & Hall, London, Chap 10). A particularly preferred copolymer is obtained by reaction of polymer resins of formula II and III as hereinbefore defined where R¹ is ⁱOCN and R² is OH, wherein resin of formula III is prepared by reaction of resin of formula II with a di isocyanate under reflux, by known means. Preferably di isocyanate is selected from toluene di isocyanate (TDI) methylene bis diphenyl isocyanate (MDI) and its many variants, isophorone di isocyanate (IPDI), hexa methylene di isocyanate (HDI), hydrogenated MDI and tetra methylene xylene di isocyanate (TMDI), preferably toluene di isocyanate (TDI).

In a further aspect of the invention there is provided a method for adhering and/or releasing substrates comprising wetting one or both substrates with an agent of formula I as hereinbefore defined at a temperature Tₚ in excess of that corresponding to its ODT, and lowering to a temperature Tₛ at or below the ODT, optionally with application of pressure. Preferably the method is for reactive hot melt or pressure sensitive adhesion, of substrates optionally with subsequent cross linking in the presence of moisture by incident radiation.

In a further aspect of the invention there is provided a method for selecting an agent for adhering and/or releasing substrates comprising selecting polymers of formula II and III, being compatible with one of each of the substrates to be adhered and/or released and determining the appropriate molecular weight of a block copolymer of the monomer pair II and III to give ODT at temperature Tₜ substantially between the processing temperature Tₚ and the service temperature Tₛ.

In a further aspect of the invention there is provided a computer programmed to select an agent according to the method as hereinbefore defined, wherein the computer is programmed with data relating to values for Chi N of each block copolymer combination for a plurality of polymers II and III as hereinbefore defined and for a range of temperatures, which is useful for selection of agents of formula I having Chi N having a desired value in the range 5-60 for any desired polymer blocks A and B as hereinbefore defined.

In a further aspect of the invention there is provided the use of a kit, a polymer resin, a composition or a method for adhering and/or releasing incompatible substrates, as hereinbefore defined, preferably for temperature switchable adhesion and release, more preferably for adhering substrates in packaging, surgery, aqua systems, micro electronics, aerospace and the like. Selection of adhesion-release kit or agent may be appropriate to the intended use, whereby certain polymer resins I and II are suited for certain uses.

The invention is now illustrated in non-limiting manner with reference to the Examples and Figures wherein

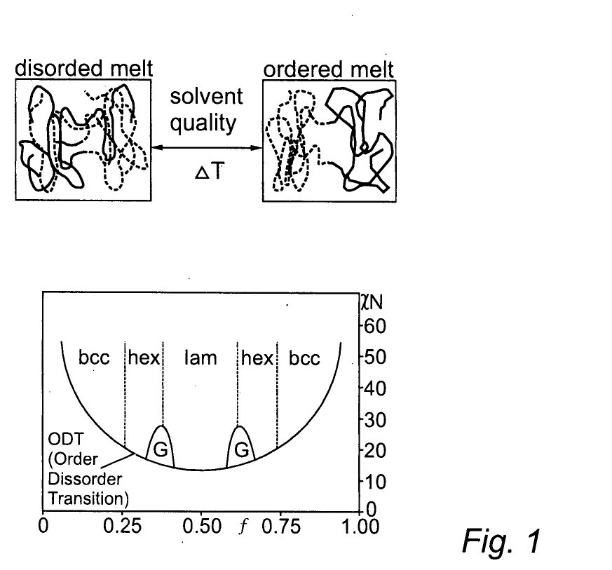

FIG. 1 illustrates the ODT of block copolymers and presents a schematic phase diagram

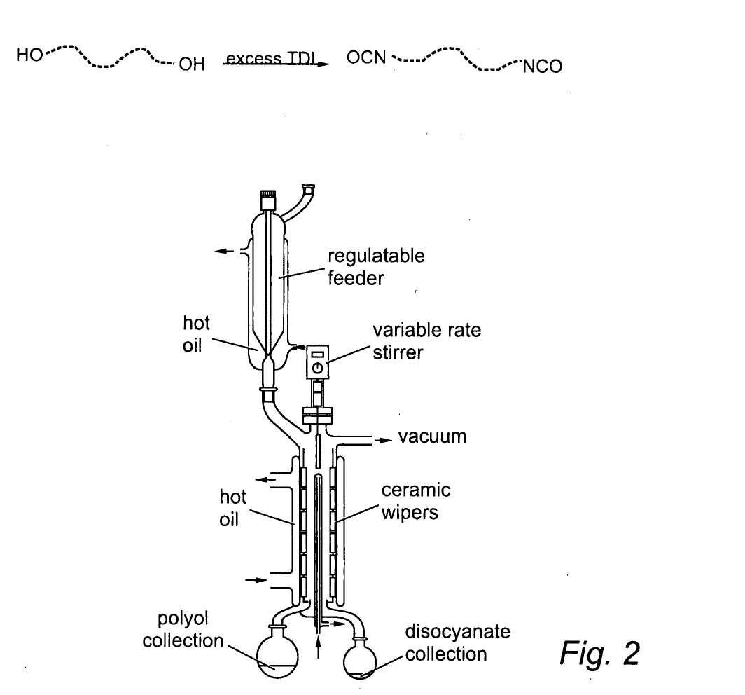

FIG. 2 illustrates the preparation of preferred isocyanate ended monomer from hydroxy ended monomer and

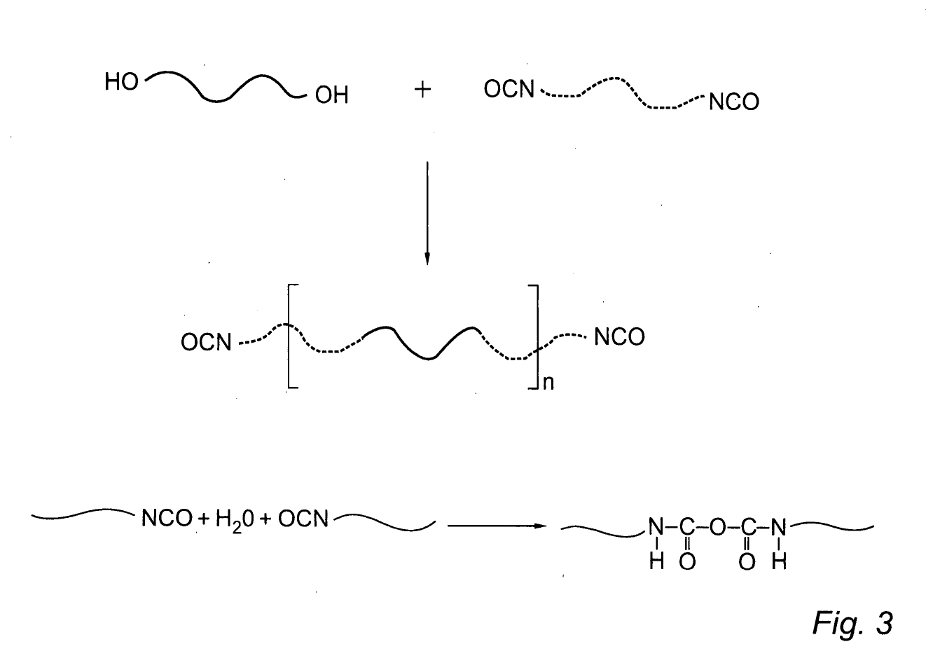

FIG. 3 illustrates the copolymerisation of preferred hydroxy and isocyanate ended monomers II and III and moisture curing of isocyanate end groups.

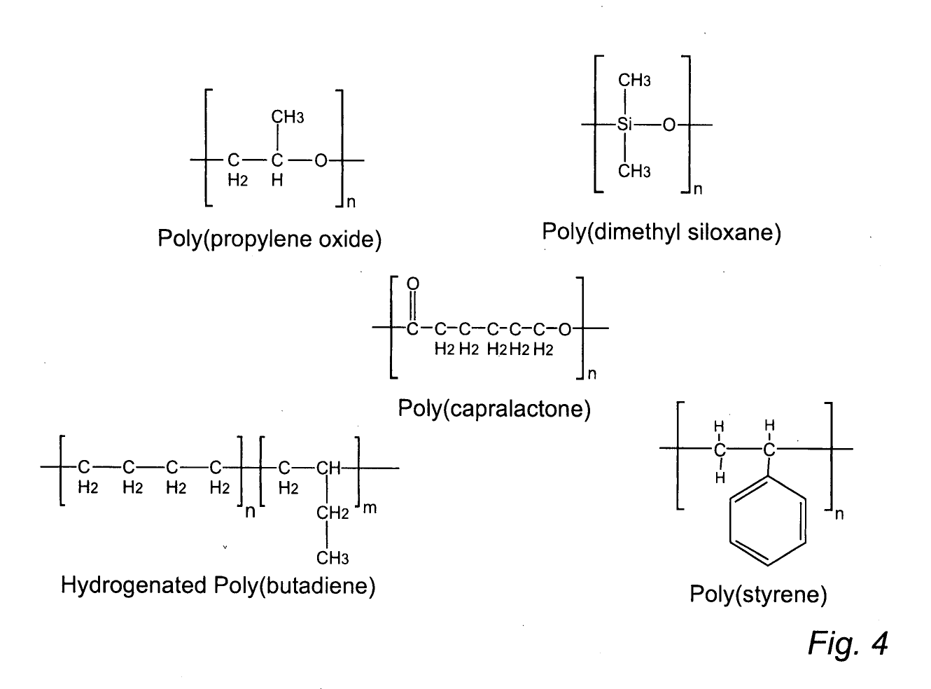

FIG. 4 illustrates the polymer “blocks” for an example adhesion-release kit or “toolbox” according to the invention.

The synthesis of interfacing agents is described in the following examples, and molecular weight and ChiN determined, given in Table 1. Adhesion and release was determined for a number of substrates and the results are given in Table 2.

### EXAMPLE 1

1. 30 g of a commercial dihydroxy-terminated poly(propylene oxide) of molecular weight 8000 (ACCLAIM 8200) in absence of solvent was reacted with a large excess of toluene diisocyanate (TDI) to produce an isocyanate terminated polymer as illustrated in FIG. 2 STEP 1. This was achieved by very slow addition of the prepolymer to the TDI at 50° C. with rapid stirring and under an inert atmosphere. The excess of TDI was then removed using short-path distillation equipment, as illustrated in FIG. 2 STEP 2 under high vacuum, at high temperature and over a high surface area.

2. 14 g of the isocyanate-terminated polymer was then reacted with 14 g of monohydroxy-terminated polystyrene of molecular weight 8000 in azeotropically dried benzene under conditions of reflux for 24 hours. The polystyrene was polymerized by anionic polymerization, followed by end-capping with a single unit of ethylene oxide, and then terminating with acidified methanol. The resulting mixture was then “killed” by the addition of dry ethanol to cap any remaining isocyanate in order to analyse the product.

### EXAMPLE 2

1. 30 g of a commercial dihydroxy-terminated poly(propylene oxide) of molecular weight 8000 (ACCLAIM 8200) was reacted in absence of solvent with TDI to give an isocyanate terminated polymer using the same technique as in step 1 of Example 1.

2. 7 g of the isocyanate-terminated polymer was then reacted with 7 g of monohydroxy-terminated polystyrene of molecular weight 4000. This was carried out in the same manner as described in step 2 of Example 1.

### EXAMPLE 3

1. 30 g of a commercial dihydroxy-terminated poly(propylene oxide) of molecular weight 4000 (ACCLAIM 4200) was reacted in absence of solvent with TDI to give an isocyanate terminated polymer using the same technique as in step 1 of Example 1.

2. 25 g of the isocyanate-terminated polymer was then reacted with 25 g of monohydroxy-terminated polystyrene of molecular weight 2000. This was carried out in the same manner as described in step 2 of Example 1.

### EXAMPLE 4

1. 30 g of a commercial dihidroxy-terminated poly(propylene oxide) of molecular weight 4000 (ACCLAIM 4200) was reacted in absence of solvent with TDI to give an isocyanate terminated polymer using the same technique as in step 1 of Example 1.

2. 12 g of the isocyanate-terminated polymer was then reacted with 24 g of monohydroxy-terminated polystyrene of molecular weight 4000. This was carried out in the same manner as described in step 2 of Example 1.

### EXAMPLE 5

1. 23 g of a commercial sample of a hydrogenated dihydroxy-terminated polybutadiene of molecular weight 4000 (KRATON 2203) was reacted in absence of solvent with TDI to give an isocyanate terminated polymer using the same technique as in step 1 of Example 1.

2. 6 g of the isocyanate-terminated polymer was then reacted with 6 g of monohydroxy-terminated polystyrene of molecular weight 2000. This was carried out in the same manner as described in step 2 of Example 1.

### EXAMPLE 6

1. 30 g of a commercial dihydroxy-terminated poly(propylene oxide) of molecular weight 4000 (ACCLAIM 4200) was reacted in absence of solvent with TDI to give an isocyanate terminated polymer using the same technique as in step 1 of Example 1.

2. 28 g of the isocyanate terminated polymer was then reacted with 28 g of a commercial dihydroxy-terminated polycaprolactone (CAPA 222 LP) of molecular weight 2000. This was carried out in the same manner as described in step 2 of Example 1, and as illustrated in FIG. 3 STEP 3.

### EXAMPLE 7

1. 20 g of a commercial dihydroxy-terminated poly(dimethylsiloxane) of molecular weight 5000 was reacted with TDI using THF as a solvent to give an isocyanate terminated polymer using the same technique as in step 1 of Example 1.

2. 12 g of the isocyanate terminated polymer was then reacted with 16 g of a monohydroxy-terminated polystyrene of molecular weight 4000. This was carried out in the same manner as described in step 2 of Example 1.

### EXAMPLE 8

1. 29 g of a commercial sample of a hydrogenated dihydroxy-terminated polybutadiene of molecular weight 4000 (KRATON 2203) was reacted with TDI using toluene as a solvent to give an isocyanate terminated polymer using the same technique as in step 1 of Example 1.

2. 10 g of the isocyanate terminated polymer was then reacted with 2 g of a commercial dihydroxy-terminated polycapralactone (CAPA 222 LP) of molecular weight 2000. This was carried out in the same manner as described in step 2 of Example 1.

### EXAMPLE 9

1. 30 g of ACCLAIM 8000 (PPO) of molecular weight 8000 was reacted in absence of solvent with TDI to give an isocyanate terminated polymer using the same technique as step 1 of Example 1.

2. 4 g of the isocyanate terminated polymer was then reacted with 2 g of a commercial α,ω-dihydroxy terminated (MW=6700) polystyrene in the same manner as step 2 of Example 1 to give a multiblock copolymer.

### EXAMPLE 10

1. 29 g of hydrogenated polybutadiene multiblock (KRATON) of molecular weight 8000 was reacted using Toluene as a solvent with TDI to give an isocyanate terminated polymer using the same technique as step 1 of Example 1.

2. 2 g of the isocyanate terminated polymer was then reacted with 2 g of a commercial dihydroxy terminated polystyrene of molecular weight 6700, in the same manner as step 2 of Example 1 to give a multiblock copolymer.

TABLE 1

| Polymer Pair | Molecular Weights | N |
|---|---|---|
| PS/PPO Tri-block | 8000/8000/8000 | 46.2 |
| PS/PPO Tri-block | 4000/8000/4000 | 31.0 |
| PS/PPO Tri-block | 2000/4000/2000 | 15.5 |
| PS/PPO Tri-block | 4000/4000/4000 | 23.1 |
| HydPBD/PS | 4000/2000 | 127.2 |
| Multi-block | | |
| PCL/PPO | 2000/4000/2000 | 39.3 |
| Tri-block | | |
| PS/PDMS | 4000/5000/4000 | 80.9 |
| Tri-block | | |
| PCL/HydPBD | 2000/4000 | 34.4 |
| Multi-block | | |
| PS/PPO | 6700/8000 | 29.1 |
| Multi-block | | |
| PS/HydPBD | 6700/8000 | 266.9 |
| Multi-block | | |

### EXAMPLE A1

### Adhesive

Adhesives were selected from the “Toolbox” according to the variables: polymer structure, molecular weight and solvent/plasticizer, to prepare a copolymer lying close to its ODT for maximum energy dissipation, which would adhere desired substrates.

The adhesive was heated to a processing temperature Tₚ above a service temperature T_{S} of 10-40° C. and was applied as a thin film to a substrate. A same or different substrate was placed on top of the film and rollered to stick. As the temperature cooled through the ODT temperature, adhesion took place, by the mechanism illustrated in FIG. 1. Microphase separation ensured that each film surface presented an affinity for the adjacent substrate. The adhered substrates were usable at a service temperature T_{S}.

### EXAMPLE A1

### Temperature Switchable Adhesive

The adhesive was applied as in Example A1. In this case the adhesive nature depends on χN. Typically the adhesive will be at χN_{ODT} and decrease in temperature will cause and increase in χN. For a sample to lose its adhesive properties a value of 1.5 times χN_{ODT} is required, which for a polymer with its ODT at room temperature means cooling by approximately 100° C. Temperature switching to a temperature of approximately −25° C. resulted in release of adhesive, allowing separation of substrates. If readhesion is required, the temperature is simply switched back to processing temperature and recooled to service temperature, passing again through ODT. If permanent adhesion is required, moisture curing is achieved as illustrated in FIG. 3.

### EXAMPLE R1

### Release Agent

The release agent was heated to a processing temperature Tₚ and applied as a thin film to a mould prior to introducing a substrate to be moulded into the mould. The moulding operation was conducted with gelling or precuring of the moulded piece. The mould with moulded substrate was then cooled to the service temperature Tₛ for the release agent and release occurred. The moulded substrate was found to have excellent surface smoothness.

The methods of Examples A1, AR1 and R1 were carried out with adhesives and release agents of Examples 1 to 10, with different substrates. The results are shown in Table 2.

TABLE 2

| Copolymer | |
|---|---|
| Pairing | Substrates Adhered to |
| (1-4) | Paper, glass, polystyrene, HDPE, |
| | LDPE, cellulose acetate, PVC, |
| | polycarbonate. |
| (5) | HDPE, LDPE, |
| (6) | Paper, PVC, nylon, cellulose acetate |
| (7) | For use as mould release agent |
| (8) | LDPE, HDPE, PET, polycarbonate, |
| | nylon, PVC, cellulose acetate |
| (9) | Paper, glass, polystyrene, HDPE, |
| | LDPE, cellulose acetate, PVC, |
| | polycarbonate |
| (10) | HDPE, LDPE |

Analysis & Properties of Block Copolymers

The chemical structure of copolymer was determined by NMR, size exclusion chromatography and MALDI-TOF mass spec. The molar mass and its distribution were determined by GPC and mass spectrometry. The morphology of the block copolymer was studied using TEM, SEM and optical microscopy. ODT was determined using rheology. Glass transition temperatures were determined by DSC and temperature resolved SAXS.

The adhesive bond obtained between substrates was determined by means of peel restraint tests, to characterise materials, together with double cantilever tests indicating fracture mechanics of adhesive joints. Finally adhesive bond failure mechanism were studied by direct imaging of de-bonding.

Test Methods—Adhesion

Adhesives are tested using ASTM Method D903. This involves the adhesive being heated to above its operating temperature, before being applied as a thin film (of known thickness) to a stainless steel test piece. A material strip is then placed on top of the film and is rollered to stick. The force required to peel the material strip from the stainless steel test piece is measured using an Instron tensile testing machine.

For pressure-sensitive adhesion the adhesive is dissolved in a solvent (Toluene) and then applied to the metal test piece. The solvent is then evaporated off and the material strip applied.

Test Methods—Release

The same method is used for release agents as for adhesives.

1. Kit of adhesion agents for adhering substrates, wherein the kit comprises a plurality of reactive block copolymers of formula I, in substantial absence of added tackifying resin or plasticiser:
R¹-(AB)ₘ(A)ₙ-R² I
wherein n=0 or 1 and when n=0 R¹ is different from, and reacts with R², when n=1 R¹=R², and wherein m=1 or a whole number integer, and
wherein each copolymer I has a molecular weight in the range 2000-20,0000, A and B are blocks of repeating units selected from known thermoplastic resin types and are substantially immiscible and R¹ and R² comprise reactive end groups, wherein the block copolymers have order-disorder transition (ODT) at a temperature Tₜ in the range 10-75° C. corresponding to a desired range of adhesion application temperatures, and are liquid at a processing temperature Tₚ and solid at a service temperature Tₛ, wherein adhesion is determined for any given substrate pair to be adhered, according to the ODT which is provided as a function of temperature and of molecular weight for each block copolymer.

2. Kit as claimed in claim 1 wherein the agents are alternatively or additionally release agents for releasing substrates, having ODT at Tₜ corresponding to a desired range of release application temperatures.

3. Kit as claimed in any of claims 1 and 2 wherein Tₚ>Tₜ>T_{S}.

4. Kit as claimed in any of claims 1 to 3 wherein reactive block copolymers I are characterised by a value Chi N at the service temperature T_{S} in the range 5-60, wherein Chi is equal to a/T+b, in which T is temperature and a and b are known system dependent constants related to the polymer type, T=T_{S} and is in the range 0-100° C., N is the degree of polymerisation given by NMo=MW, Mo is the molecular weight of a monomer unit, and MW is the molecular weight of the polymer.

5. Kit as claimed in any of claims 2 to 4 for temperature switchable adhesion and release of substrates with release by cooling significantly below ODT, wherein copolymer I has Chi N_{ODT} at a temperature T_{T} just above the service temperature Tₛ and has Chi N_{R} at a release temperature T_{R}, wherein T_{S}<T_{R}.

6. Kit as claimed in any of claims 1 to 5 wherein Chi N_{R} is approximately 1.5 Chi N_{ODT}.

7. Kit as claimed in any of claims 1 to 6 wherein selection of block copolymer of relatively higher MW providing better phase separation requires selection of polymer type having relatively low Chi for ODT or selection of block copolymer of relatively lower MW requires selection of polymer type having relatively large Chi for ODT, providing tackiness or adhesion.

8. Kit as claimed in any of claims 1 to 7 for adhering any compatible or incompatible substrates, by means of a film of adhesion-release agent therebetween wherein each surface of the film is compatible with the surface it is in contact with, selected from polar and non-polar surface, porous materials, and non-porous materials and the like.

9. Kit as claimed in any of claims 1 to 8 wherein an adhesion-release agent is a releasable adhesive which reorders on application of heat or pressure, or is semi or permanently bonding, by means of cross linking formation on application of moisture or radiation such as UV or the like.

10. Kit as claimed in any of claims 1 to 9 wherein a plurality of reactive block copolymers of formula I are characterised by each A and R¹ and/or each B and R¹ respectively of the same type and a range of molecular weights, provided in a plurality of MW sub ranges selected from 2000-4000, 4000-5000, 5000-6000, 6000-8000, 8000-12000 and 12000-20,000.

11. Kit as claimed in any of claims 1 to 10 wherein A and B are selected from blocks comprising any thermoplastic polymers, which may be the same as one of the dissimilar substrates to be adhered, thereby having an affinity for the substrate, or may be different to the substrate but have an affinity therefor, selected from polybutadiene (PB), poly(ethylene terephthalate) (PET), polyether, polyester, polyamide, polyolefins such as polypropylene (PP) or polyethylene (PE), polycaprolactone (PCL), polystyrene (PS) and poly(ethylene oxide) (PEO).

12. Kit as claimed in claim 11 wherein affinity is determined in terms of similar solubility parameters.

13. Kit as claimed in any of claims 1 to 12 wherein each R¹ and R² independently are selected from the reactive end groups OH, OR, halo (Cl, I), ⁱOCN, CO₂H, NH₂, CONH₂ and CO₂R.

14. Kit as claimed in any of claims 1 to 13 wherein each R¹ independently is selected from OH, OR, CO₂H, CO₂R and each R² independently is selected from ⁱOCN and OCOC(CH₃)═CH₂.

15. Kit as claimed in any of claims 1 to 14 wherein an agent is selected from a di, tri or multi block copolymer.

16. Kit of polymer resins of formula II and III which are suitable for preparing a kit of block copolymers of formula I as defined in any of claims 1 to 15 in desired MW for any given polymer pair AB:
II R¹AR¹ III R²BR²
Wherein R¹, R², A and B are as defined in any of claims 1, 11 and 13.

17. A block co-polymer adhesion-release agent of formula I
R¹-[AB]ₘ(A)ₙ-R² I
Wherein R¹, R², A and B, n and m are as hereinbefore defined in claims 1 and 11 and one or both of R¹ and R² is ⁱOCN, and if R² is different from and reactive with R¹, R² is OH providing a copolymer molecular weight in the range 2,000 to 20,000.

18. An adhesion-release agent of formula I, or polymer resin of formula II or III for the preparation thereof, for use in a kit as defined in any of claims 1 to 15 or 16.

19. Composition comprising polymer resins of formulae II and III as defined in claim 16 or formula I as defined in any of claims 1 to 15, in substantial absence of added tackifying resin, plasticizer and the like.

20. Process for the preparation of an adhesion-release agent as defined in claims 17 or 18 for use in a kit as hereinbefore defined in claims 1 to 17 comprising the condensation of a polymer resin of formula II with a polymer resin of formula III as hereinbefore defined in claim 15 under reaction conditions of elevated temperature and/or pressure, with termination of polymerisation at desired degree of polymerisation N or molecular weight by addition of end capping component or by reaction quench, for example temperature or pressure reduction or removal of solvent, if present.

21. Method for adhering and/or releasing substrates comprising wetting one or both substrates with a agent of formula I as hereinbefore defined in any of claims 1 to 15 at a temperature Tₚ in excess of that corresponding to its ODT, and lowering to a temperature Tₛ at or below the ODT, optionally, with application of pressure.

22. Method for selecting an agent of formula I for adhering and/or releasing substrates, as defined in any of claims 1 to 15, comprising selecting polymers of formula II and III as defined in claim 16, being compatible with one of each of the substrates to be adhered and/or released and determining the appropriate molecular weight of a block copolymer of the monomer or polymer pair II and III to give ODT at temperature Tₜ substantially between the processing temperature Tₚ and the service temperature Tₛ, wherein adhesion is determined for any given substrate pair to be adhered, according to the ODT which is provided as a function of temperature and of molecular weight for each block copolymer.

23. Method as claimed in claim 22 wherein an agent of formula I is selected by using a computer programmed with data relating to values for Chi N of each block copolymer combination for a plurality of polymers II and III as hereinbefore defined in claim 16 and for a range of temperatures which is useful for selection of agents of formula I having Chi N having a desired value in the range 5-60 for any desired polymer blocks A and B as hereinbefore defined in any of claims 1 to 15, wherein adhesion is determined for any given substrate pair to be adhered, according to the ODT which is provided as a function of temperature and of molecular weight for each block copolymer.

24. Use of a kit, a polymer agent, a composition, a method for adhering and/or releasing incompatible substrates or a programmed computer-aided method as hereinbefore defined in any of claims 1 to 15, 16, 17, 18, 19, 21, 22 or 23, preferably for temperature switchable adhesion and release, more preferably for adhering substrates in packaging, surgery, aqua systems, micro electronics, aerospace and the like.

25. A kit, polymer agent, composition or method as hereinbefore described or illustrated in the description and/or figures.
